(19) United States
(12) Patent Application Publication
(10) Pub. No.: US 2015/0173348 A1
(43) Pub. Date: Jun. 25, 2015

(54) ORGAN CHAMBER FOR EX VIVO WARM PERFUSION

(71) Applicant: Lauren Brasile, Albany, NY (US)

(72) Inventor: Lauren Brasile, Albany, NY (US)

(73) Assignee: BREONICS, INC., Albany, NY (US)

(21) Appl. No.: 14/240,923

(22) PCT Filed: Aug. 27, 2012
(86) PCT No.: PCT/US2012/052528

§ 371 Date: Jun. 9, 2014

Related U.S. Application Data
(60) Provisional application No. 61/527,183, filed on Aug. 25, 2011.

(51) Int. Cl. A01N 1/02

(52) U.S. Cl. CPC A01N 1/0247; A01N 1/0242

(57) ABSTRACT

An exsanguinous metabolic support system for maintaining an organ or tissue at a near normal metabolic rate is disclosed. The system employs an organ chamber comprising an oxygenator in the perfusion fluid paths for controlling respiratory gases. The oxygenator may contain three pouches for gaseous exchange of the perfusion solution. A controlled gassing subsystem for regulating respiratory gases and maintaining the pH of the perfusion solution is also employed by the system and delivers oxygen and carbon dioxide to the pouches of the oxygenator. The organ chamber additionally includes a perfusion subsystem including the perfusion fluid paths, a container for holding the organ in the perfusion fluid paths with one or more perfusion solution inlets. The organ chamber may additionally include a conduit for receiving venous outflow of perfusion solution and preventing its contact with the outer surfaces of the organ.

### CROSS-REFERENCE TO RELATED APPLICATION

This application claims the priority benefit under 35 U.S.C. §119(e) of U.S. provisional patent application No. 61/527,183 filed Aug. 25, 2011, which is incorporated herein by reference in its entirety.

### FIELD OF THE INVENTION

The invention relates to a metabolic support system for sustaining organs for transplantation under near-physiologic conditions. More particularly, the invention relates to the organ chamber of the system and its use in supporting synthetic functions required for active repair and/or long-term maintenance of organs for transplantation, prognostication of posttransplantation organ function, delivery of cell-based therapies, immunomodification and transport of an organ intended for transplantation.

### BACKGROUND

The limiting factor in organ transplantation today is the world-wide shortage of transplantable organs. In cases of end-stage cardiac and liver diseases, the vast majority of patients die each year waiting for an allograft.

In the case of kidney failure, there are currently more than 400,000 patients in the U.S. with end-stage renal disease, or ESRD, that have progressed to a point of little to no kidney function. There is no cure and only two therapies are available; kidney transplantation or dialysis. Of the two therapies transplantation is preferred both for cost effectiveness and “quality of life”. However, the kidney transplant field is limited by availability of suitable donor kidneys, resulting in multi-year waiting lists for ESRD patients.

There are two sources of kidney allografts for these patients with end-stage renal disease: a kidney donated from a live donor, usually a relative, or a kidney procured from a deceased donor. Hypothermic (4° to 8° C.) preservation that is used in simple static storage or cold perfusion (pumping of fluids) has been the standard methods for the preservation of organs from deceased donors. The hypothermic preservation functions by the inhibition of oxidative metabolism that slows the rate of ischemic damage to the organ. Nevertheless, hypothermic preservation of organs is limited in application to only a small number of cadaveric donors and remains largely dependent upon the traditional deceased by brain death donor (DBD), those patients who are on life-support in intensive care units. The DBD donor represents a small fraction of the patients that expire each year from traumatic injuries, approximately 4%.

The chronic organ shortage has led to the use of extended donor criteria by recovering kidneys from older donors and those with preexisting conditions such as a history of hypertension, obesity, type II diabetes, serum creatinine greater than 1.5 mg/dL, etc. that render them less than ideal. These donors are referred to as the extended criteria donors (ECD). The transplantation of ECD kidneys has resulted in inferior graft function and survival in comparison to the results of DBD kidneys. In addition, a small number of transplant centers in the U.S. have instituted programs to recover kidneys from patients in the ICU that have planned removal of life-support. This category of patients is referred to as the controlled deceased by cardiac death (DCD) donor. Kidneys procured from the controlled DCD have a limited period of warm ischemia that is the reason they are referred to as “controlled”. However, the use of the controlled DCD represents a marginal increase in the number of kidneys available for transplantation.

The vast majority of patients dying from traumatic injuries never make it to an intensive care unit but rather expire at the site of the injury, in the ambulance or in the emergency room and are referred to as the uncontrolled deceased by cardiac death (uDCD). These patients are never considered for organ donation because the period of warm ischemia (WI) of greater than 45-minutes has represented an insurmountable obstacle to transplantation. Hypothermic organ preservation technologies have not been successful with donor kidneys recovered from uDCD patients with prolonged WI damage that represent up to 96% of a potential new donor pool.

The ability to repair ischemic damage would allow transplant centers to broaden their donor criteria beyond living, DBD, ECD or the controlled DCD donors, providing access to the very large untapped uDCD donor pool. The ability to successfully access the uDCD donor will significantly increase the number of kidney transplants.

The organ preservation technology in use clinically, and to our knowledge those technologies under development, are limited to the existing donor criteria that makes up the current donor pool. A new perfusion technology consisting of an Exsanguinous Metabolic Support (EMS) system has been shown to effectively repair ischemically-damaged kidneys in canine kidney in vivo models and in human kidney ex vivo models, with the ability to test prospectively the viability of a recovered kidney's renal function prior to transplantation. The concepts underlying the development of the EMS system are based on two key points: (1) providing sufficient nutrients and biological factors to support and maintain ongoing cellular metabolism in the kidney allograft, and (2) preserving the barrier functions of the vascular endothelium in the kidney. Use of the EMS system would significantly expand the number of organ donors to include uDCD donors who have been without a heartbeat for up to two hours.

The summary of preclinical data to date has demonstrated that the major limiting factor in using the uDCD kidney is hypothermia. The EMS technology eliminates the need for hypothermia and as such uDCD kidneys with severe warm ischemic injury can be successfully transplanted. With the use of EMS technology, without a period of hypothermia, severe warm ischemic injury of as much as two hours can be overcome and normal renal function can be regained. The ability of the EMS technology to overcome a severe ischemic insult is based upon the ex vivo resuscitation of oxidative metabolism of sufficient magnitude for there to be cellular reparative processes while kidneys are being perfused ex vivo. The ex vivo metabolism and cellular repair processes can be quantified during EMS perfusion allowing for the identification of primary non-function prospectively and also for the sequential evaluation of the recovery processes. The EMS technology has been used with 22 discarded human allografts and has demonstrated ex vivo proof of concept.

Thus, there is a need for a system that employs a near-normothermic preservation that supports active cellular reparative processes due to warm ischemic damage upon cardiac arrest. Portability and automation of the system is important, particularly in situations where the system is used to initiate organ resuscitation and repair in situ or ex vivo following cardiac arrest at external sites where the cardiac arrest has occurred.

### SUMMARY

In one aspect, the invention relates to an organ chamber for use in a system for preserving an organ, resuscitating oxidative metabolism, repairing organ damage, restoring synthetic functions and applying cell-based therapies for regenerative medicine. The system includes a perfusion subsystem with one or more perfusion fluid paths for circulating a perfusion solution. The system also includes an oxygenator or oxygenator subsystem in the perfusion fluid paths including at least one gaseous exchange pouch, an inlet at the superior end of the pouch, and an outlet at inferior end of the pouch. Further, the system comprises a container for holding an organ situated in the perfusion fluid path and including one or more perfusions solution inlets and outlets. The system also includes a controlled gassing subsystem for regulation of respiratory gases and the tight maintenance and control of the pH of the perfusion solution including a first controller for continuously introducing oxygen at a constant concentration into the perfusion solution and a second controller for intermittently introducing carbon dioxide into the perfusion solution wherein the second controller has a set point for activation and deactivation of the second controller. The first controller may also have the simultaneous ability to modify the constant O₂-tension to a targeted value. The system also includes a temperature controller for controlling temperature of the perfusion solution.

In another aspect, the invention relates to an oxygenator for an organ chamber including at least one gaseous exchange pouch, an inlet at the superior end of the pouch, and an outlet at the inferior end of the pouch. The inlet may be coupled to a reservoir of venous effluent from an organ and the outlet may allow for the re-oxygenated venous effluent to be recirculated to the organ. The oxygenator may include three gaseous exchange pouches. The three gaseous exchange pouches may include

The organ chamber may also include a conduit for delivering venous outflow of a perfusion solution being circulated through the organ from the organ directly to a reservoir. The organ chamber may also include at least one sensor for monitoring at least one parameter of the perfusion solution selected from flow rate, pH, PaO₂, PaCO₂, temperature, vascular pressure, NO flux, cytokine/chemokine synthesis and a metabolic indicator such as oxygen consumption, glucose consumption, consumption of at least one citric acid cycle component, CO₂ production and the like. A second sensor may be placed in the arterial supply to the cannulated artery of the organ. The first and second sensors provide the ability to measure the difference across the organ to obtain accurate measurements of metabolism.

In yet another aspect, the invention relates to an organ chamber further comprising at least one warm preservation system component, for example, a reservoir, a heat exchanger, an oxygenator, and/or a pump. Alternatively, the organ chamber of the present invention comprises connectors for releasably connecting the organ chamber to an external warm preservation system.

In yet another aspect, the invention relates to a method for preserving an organ comprising placing the organ within a container on a resilient support member. The organ is then connected to a warm preservation system such as the metabolic support system of the present invention and perfused with a warm preservation solution providing all the trophic factors requisite for maintaining the organ at a near normal rate of metabolism.

In another related aspect, the invention relates to a method for the maintenance of an organ or tissue for transplantation, comprising the steps of establishing and maintaining the organ in a warm preservation system comprising the organ chamber including the oxygenator and the gassing subsystem of the present invention and monitoring the functional integrity of the organ.

In another aspect, the invention relates to the use of the oxygenator of the present invention in conjunction with a warm perfusion system to support continued de novo syntheses sufficiently for an active repair process to ensue.

These, and other objects, features and advantages of this invention will become apparent from the following detailed description of the various aspects of the invention taken in conjunction with the accompanying drawings.

### BRIEF DESCRIPTION OF DRAWINGS

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention.

FIG. 1 shows an embodiment of an exsanguinous metabolic support system including an organ chamber for ex vivo warm perfusion with three gaseous exchange pouches, in accordance with one aspect of the present invention;

FIG. 2 shows another embodiment of an exsanguinous metabolic support system including an organ chamber for ex vivo warm perfusion having three gaseous exchange pouches, in accordance with one aspect of the present invention;

FIG. 3 shows yet another embodiment of an exsanguinous metabolic support system including an organ chamber for ex vivo warm perfusion with three gaseous exchange pouches and two perfusion paths, which are suitable for preservation of a liver, in accordance with one aspect of the present invention;

FIG. 4 shows a top view of a gaseous oxygenating pouch, in accordance with one aspect of the present invention;

FIG. 5 shows a side view of the oxygenator subsystem, in accordance with one aspect of the present invention;

FIG. 6 shows an isometric top view of the oxygenator subsystem, in accordance with one aspect of the present invention;

FIG. 7 shows an isometric bottom view of the oxygenator subsystem, in accordance with one aspect of the present invention; and

FIG. 8 shows a front view of the oxygenator subsystem, in accordance with one aspect of the present invention.

### DETAILED DESCRIPTION OF THE INVENTION

All patent applications, patents and literature references cited herein are hereby incorporated by reference in their entirety.

In the description that follows, certain conventions will be followed as regards the usage of terminology: The term “organ, tissue or section of anatomy” refers to an excised viable and whole section of the body to be maintained as such in the exsanguinous metabolic support system (“EMS”) of this invention, and refers to an intact organ including, but not limited to, a kidney, heart, liver, lung, small bowel, pancreas, brain, eye, skin, limb, anatomic quadrant or bioengineered tissue construct. The term “organ product” refers to any substance generated as the result of the secretory function of an organ, frequently a fluid, for example, bile from liver, urine from kidneys, but also includes mechanical functions such as kidney filtration or heart pumping.

The terms “preservation solution,” “resuscitation and repair solution,” “perfusion solution,” and “perfusate” are used interchangeably and refer to a non-blood buffered physiologic solution that provides means for reestablishing cellular integrity and function in organs which may have experienced ischemic damage prior to or during isolation and further, enables an organ or tissue to be maintained at a near normal rate of metabolism. The term “non-blood” is intended to exclude perfusates comprising substantially whole blood or its individual components. The perfusion solution of the present invention may, however, contain a minimal amount of whole blood or a blood component, for example, red blood cells, serum, plasma, or hemoglobin.

The term “pouch” is an item resembling one of the membranous sacs in animals that serve as receptacles for fluid or gas. For purposes of the present invention, the bladder, sac, or pouch, is gas permeable and increases the surface area of the perfusate passing through it thereby increasing exposure to the gas.

The process according to the present invention involves isolating an organ, tissue or specific area of anatomy from the rest of the physiologic system by removing or interrupting the arterial source of blood feeding the desired tissue(s). Likewise, the venous outflow from the organ or section of anatomy is interrupted and the venous effluent is collected. Next, the organ or tissue is flushed through the arterial system with a preservation solution, such as the one disclosed in U.S. Pat. No. 6,582,953, at a temperature of about 25°-37° C. to remove blood and blood products. The organ is then placed in an EMS system including the oxygenator subsystem and gassing subsystem or CO₂/pH control subsystem of the invention and perfused with the perfusate solution, while various parameters of the perfusion are monitored by the system and regulated as necessary to maintain adequate metabolism of the organ or tissue. Organ function is also monitored, for example, by collecting an organ product, such as urine or bile, and evaluating whether physical and chemical parameters of the organ product are within the range associated with normal function for that particular organ. The invention may optionally include, therefore, a subsystem for evaluating the functional and regenerative status of the organ. In this way, organ function can be monitored using in-line detection means and in-line testing methodology.

Perfusion of the isolated organ or section of anatomy with a solution at near physiologic temperature of about 25° C. to 37° C., in accordance with the invention, performs a number of functions. It maintains the cellular environment at physiologic pH and maintains near normal oxygenation, temperature, and osmolarity. It maintains the normal barrier function of the tissue to macromolecules, thereby resulting in stable perfusion pressures and stable vasculature flow rates. It adequately dilates and fills the vasculature, delivers adequate trophic factors to maintain a near normal level of metabolism in the isolated organ or section of anatomy and supports the ex vivo oxidative metabolism by providing high energy compounds. It supports ongoing oxidative metabolism with supplemental substrates that may include, but are not limited to, glucose, pyruvate, and uridine 5-triphosphate (UTP). The ongoing oxidative metabolism is further supported by maintaining the adenine compound pool. The citric acid cycle and the electron transport chain are supported by providing adequate substrate delivery to continue metabolic support and function in the isolated organ and tissues. The ongoing metabolism provides adequate metabolites and nutrients to maintain the tissue integrity with tight cellular functions and normal membrane polarity. In the case of warm ischemically damaged organ the oxidative metabolism is of sufficient magnitude for there to be new synthesis that is the basis for the cellular reparative processes.

The method and system of the invention allows for the removal of blood within the organ or section of anatomy and refills the vascular and pericellular spaces with a perfusate solution, while any perfusate solution may be used, the perfusate solution of U.S. Pat. No. 6,582,953 is preferred. Further, the system maintains pH, PaO₂, temperature, osmolarity, and hydrostatic pressures and delivers adequate substrate to support the metabolism necessary for cellular integrity. The ongoing metabolism supported and monitored by the organ chamber system, in combination with the perfusate solution, is of sufficient level to support the ongoing function of the specific organ or section of anatomy during the time the tissue(s) are isolated from the body or the circulatory system.

For purposes of illustration, and not limitation, the solution is perfused at a systolic pressure appropriate for the tissue(s) being maintained with the organ chamber of this invention until a flow rate is achieved which is near normal for that particular organ or tissue. By way of illustration but not limitation, a human kidney may be perfused with the solution at a systolic pressure of less than 80 mmHg with a flow rate greater than 80 cc/min. The pH is maintained in a physiologic range by the injection of CO₂ or O₂ via an oxygenator subsystem. Adequate oxygen is provided to the organ by including an oxygen transporting compound as a component of the preferred perfusate solution that is oxygenated by the gassing subsystem.

The organ chamber system according to the present invention provides the necessary oxygen delivery, nutrients for metabolism, oncotic pressure, pH, perfusion pressures, temperature, and flow rates to support adequate oxidative metabolism near the respective physiologic range. A near normal rate of metabolism as defined above is about 70-100% of normal rates of metabolism. Further, the organ chamber system according to the present invention supports a level of metabolism during the period of EMS perfusion which supports sufficient oxidative metabolism to result in the normal functional product of the organ or section of anatomy.

The EMS technology of the present invention provides, therefore, a number of advantages over conventional cold preservation methodologies: (1) Organs intended for transplantation can be maintained in a metabolically active state for a prolonged period of time prior to being transplanted during which the functional integrity of the organ can be assessed and the likelihood of its ability to function post transplantation can be evaluated; (2) Organs which were previously thought to be unsuitable for transplantation due to excess periods of warm ischemia can be resuscitated and actively repaired; (3) EMS perfusion can be used to deliver cell-based therapies for the bioengineering of tissues and organs for regenerative medicine modalities; (4) EMS perfusion provides means for targeted delivery of a therapeutic agent, for example, in chemotherapy or gene therapy; and (5) The cells within the organ or tissue can be stimulated to actively synthesize de novo compounds.

A new organ chamber is disclosed for the EMS system that maintains an isolated organ or tissue at a near normal metabolic rate. The newly designed organ chamber is comprised of individual membrane oxygenating pouches placed in tandem. The oxygenating pouches provide extreme control of the respiratory gases; in particular the PaO₂ is maintained within a tight predetermined concentration. An important aspect of the oxygenating pouches being placed in tandem is flexibility in controlling the PaO₂. With the oxygenating pouches used in tandem the PaO₂ can be substantially reduced for use with damaged organs that consume oxygen poorly due to impaired oxidative metabolism. Similarly, in cases with organs having a high rate of oxidative metabolism the PaO₂ can be raised to support increased rates of oxygen consumption.

The instant invention is described with reference to the preferred embodiments. It should be understood that the various components of the system may be combined or provided as separate parts which are implemented in the system as a matter of design choice.

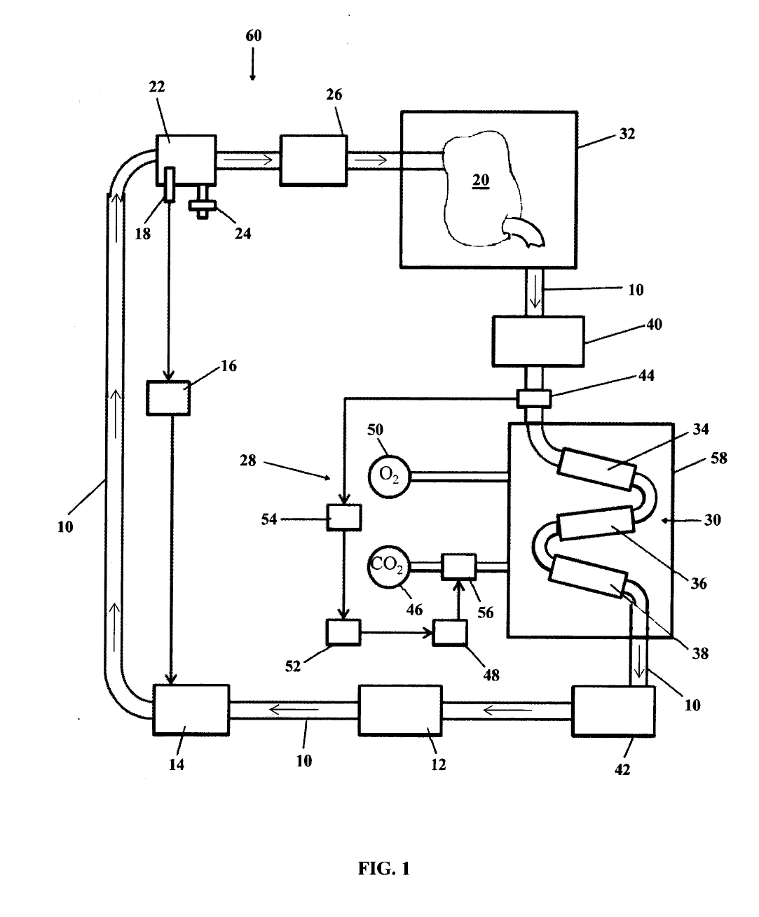

Referring to the drawings, wherein like reference numerals are used to indicate like or analogous components throughout the several views, and with particular reference to FIG. 1, there is a diagram of one embodiment of the organ perfusion circulation path of the present invention. An EMS system is disclosed and includes a cassette or organ chamber system 60 with a perfusion subsystem, an oxygenator subsystem 30, an organ chamber or container 32, a controlled gassing subsystem 28, a temperature controller 16, and ports for accessing and measuring various metabolic and reparative processes. The cassette 60 is used for ex vivo warm perfusion to maintain an isolated organ or tissue 20 at a near normal metabolic rate. All perfusate available for circulation through the cassette 60 is propelled through the circulation path 10 by a pump 12. The direction of flow of the perfusion solution is indicated by arrows within the flow path. While any pump may be used to circulate the perfusion fluid of the instant invention, a pulsatile pump, for example, Model No. RM3 (IGL Inc., Rochester, Minn.) is preferred.

Before the perfusate enters the organ 20, it passes through a heat exchanger 14, to bring the temperature within the range of 25°-37° C., the preferred temperature for optimal metabolism by the organ being in that range. The heat exchanger 14 is controlled by a temperature controller 16 which receives input from a temperature sensor 18 situated in the perfusate path 10 of the perfusion subsystem. In the depicted diagram the temperature sensor 18 is located within a bubble trap 22. In one embodiment, the temperature controller is a single unit comprising a thermocouple which senses the temperature of the perfusate and a heat exchanger which is activated by the thermocouple, when required, to maintain the temperature in the desired range. In another embodiment, the temperature may be controlled by means of a water heater for circulating warmed water around the perfusate reservoir or oxygenator. In yet another embodiment, a temperature sensor situated within the organ chamber is used to monitor and control the temperature of the perfusate. A pressure sensor 24 may also be integrated into the bubble trap 22. The bubble trap 22 debubbles the perfusate just prior to entering the organ chamber 32. In addition, a flow meter 26 may be incorporated into the warm perfusion system in the perfusate path 10 just prior to the organ 20 to measure the flow rate of the perfusate solution.

The perfusate solution, which contains an oxygen carrier, is oxygenated after contact with the organ 20 via the oxygenator subsystem 30 prior to being re-circulated through the organ 20 in organ chamber 32. The cassette 60 includes a container 58 with an oxygenator subsystem 30 that is comprised of at least one membrane oxygenating pouch, in the depicted embodiment there are three membrane oxygenating pouches 34, 36, 38 which may be placed in tandem. The terms “membrane oxygenating pouches,” “oxygenating pouches,” “gaseous exchange pouches,” and “gas permeable pouches” are used interchangeably. The oxygenating pouches 34, 36, 38 provide extreme control of the respiratory gases; in particular the PaO₂ is maintained within a tight predetermined concentration. An important aspect of the oxygenating pouches 34, 36, 38 being placed in tandem is flexibility in controlling the PaO₂. With the oxygenating pouches 34, 36, 38 used in tandem the PaO₂ can be substantially reduced for use with damaged organs that consume oxygen poorly due to impaired oxidative metabolism. Similarly, in cases with organs having a high rate of oxidative metabolism the PaO₂ can be raised to support increased rates of oxygen consumption.

Use of the cassette 60 supports de novo or continued synthesis of constituents necessary for long-term maintenance of organs for transplantation, for resuscitation and active repair of organs that have sustained warm ischemic damage and for tissue engineering by introducing cell-based and immunomodifying therapies. A variety of oxygenators have been employed in ex vivo perfusion systems to raise the PaO₂ over what can be accomplished using an acellular perfusate such as the description in U.S. Pat. No. 6,582,953. A number of neonatal and pediatric oxygenators are commercially available such as the CAPIOX RX05 and FX05, the Medtronic Minimax Plus, the Medos HILITE 2400 and LT, Maquet Quadrox-ID. The limitation of using a neonatal or pediatric oxygenator is that high efficiencies result in high PaO₂. Frequently a PaO₂ greater than 600 mmHg is encountered, which is a range that can be damaging to the vascular endothelium within an isolated organ. In order to reduce the high PaO₂, blenders are employed that introduce inert gas such as nitrogen to lower the oxygen tension. In contrast, the three oxygenating pouches 34, 36, 38 arranged in tandem provide sensitive targeting of PaO₂ by allowing different flow rates of the oxygen 50 to the individual oxygenating pouches 34, 36, 38. Similarly, the gas flow to individual oxygenating pouches 34, 36, 38 can be turned off as needed. In one embodiment the at least one gas inlet is into the container 58 which surrounds the three oxygenating pouches 34, 36, 38, the gas then flows into the oxygenating pouches 34, 36, 38 through the permeable membrane. In alternative embodiments each oxygenating pouch 34, 36, 38 includes at least one gas inlet, not shown, allowing the gas to flow directly into the oxygenating pouches 34, 36, 38.

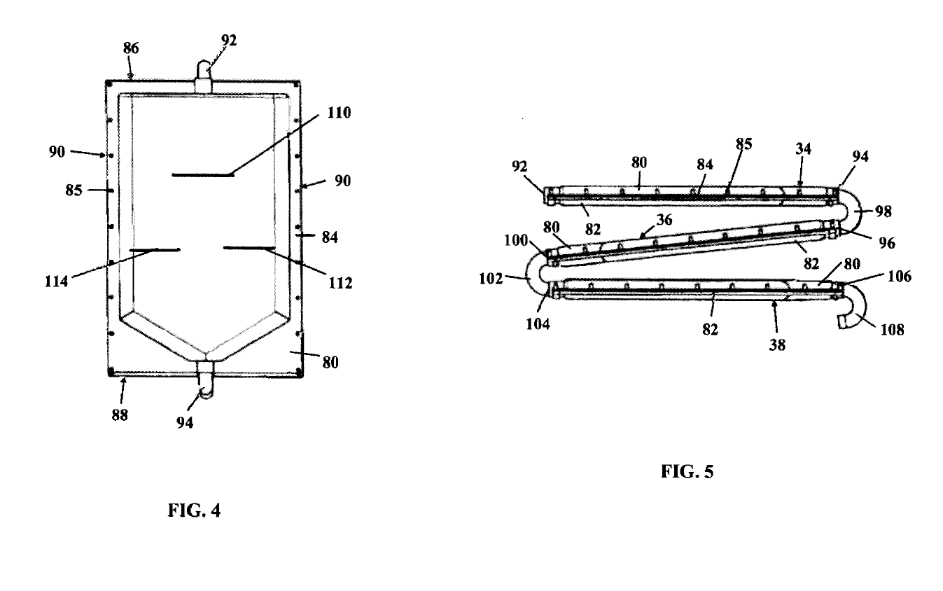

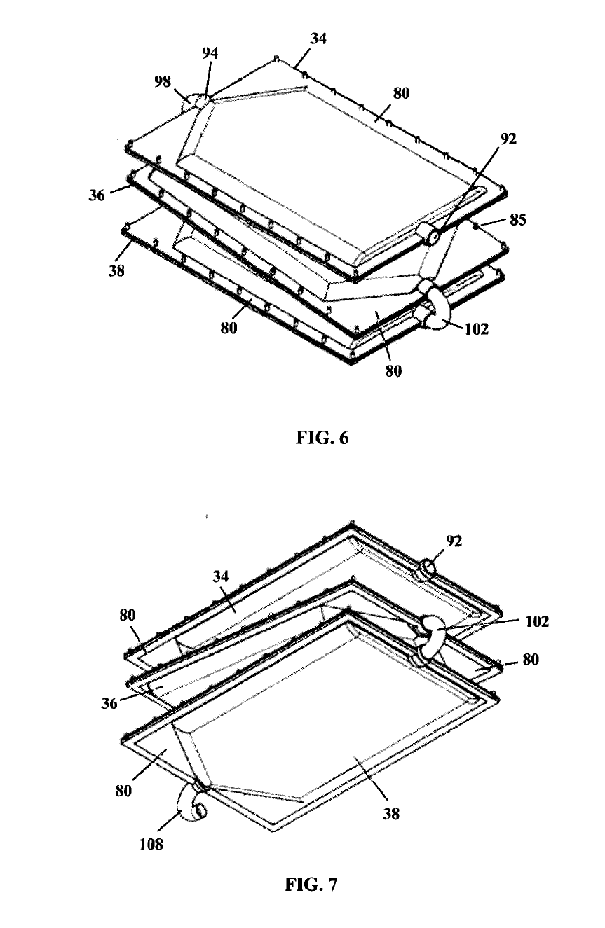

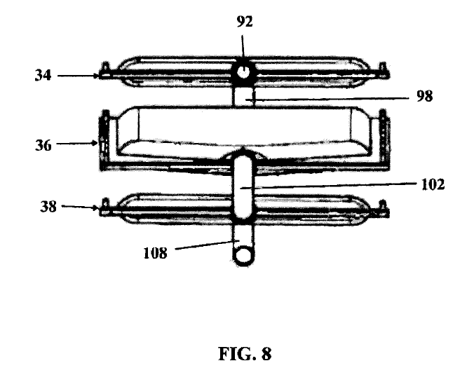

The three oxygenating pouches 34, 36, 38 are depicted in FIGS. 4-8. The oxygenating pouches 34, 36, 38 include a first sheet 80 opposing a second sheet 82 which are secured together with a perimeter seal 84. The first sheet 80 and second sheet 82 are impermeable to liquids but permeable to gases. The seal 84 creates a first end 86, a second end 88, and two sides 90. In addition, fasteners 85 may be used to reinforce the seal 84. The oxygenator subsystem 30, specifically the first sheet 80 and second sheet 82, may be fabricated from a siliconized material which is permeable to gas exchange allowing the perfusate oxygen levels and pH to be reestablished to the desired level prior to entering the organ 20. Additional materials which are permeable to gas exchange while being impermeable to liquids may also be used for the sheets 80, 82 of the oxygenating pouches 34, 36, 38.

The configuration of the membrane oxygenator 30 is that of one which is comprised of at least one and up to three membranes or pouches 34, 36, 38. The oxygenating pouches 34, 36, 38 are placed in tandem and in a tiered series which maintains gravity flow of the perfusate through the perfusate path 10 with minimum resistance. The total surface area of the oxygenator system is in the range of 100-300 square inches. The increased surface area results in a higher percentage of the circulating perfusate being in contact with the oxygenating pouches 34, 36, 38 at any given time. This increased exposure allows for the exquisite control of PaO₂ and pH. To maintain gravity flow, the pouches 34, 36, 38 are situated in a scaffold system, fabricated from a Lexan type plastic that hold their position set in reference to a level plane offset by an angle of approximately 3-10°.

The first oxygenating pouch 34 includes an inlet 92 at the first end 86 whereby the perfusion solution enters the pouch 34. The first pouch 34 also includes an outlet 94 at the second end 88 whereby the perfusion solution passes out of the pouch 34. The second oxygenating pouch 36 includes an inlet 96 at the first end 86 whereby the perfusion solution enters the oxygenating pouch 36 through a first tube 98. The first tube 98 connects the outlet 94 of the first pouch 34 and the inlet 96 of the second pouch 36 providing a passageway for the perfusate solution to pass from the first pouch 34 to the second pouch 36. The second pouch 36 also includes an outlet 100 at the second end 88 whereby the perfusion solution exits the pouch 36 and enters a second tube 102. The third oxygenating pouch 38 includes an inlet 104 at the first end 86 whereby the perfusion solution enters the third pouch 38 from a second tube 102. The second tube 102 creates a passageway between the outlet 100 of the second pouch 36 and the inlet 104 of the third pouch 38 allowing the perfusate solution to pass from the second pouch 36 to the third pouch 38. The third pouch 38 also includes an outlet 106 at the second end 88 whereby the perfusion solution exits the pouch 38 through a third tube 108. The third tube 108 creates a passageway for the perfusion fluid to travel to the arterial reservoir 42.

The oxygenating pouches 34, 36, 38 may also include at least one diversion region 110. The diversion region 110 is created by fusing the first sheet 80 and the second sheet 82 to divert the perfusate solution from following a straight path from the inlets 92, 96, 104 to the outlets 94, 100, 106 as the perfusate solution passes through oxygenating pouches 34, 36, 38. In the depicted embodiment there are three diversion regions 110, 112, 114. A first diversion region 110 may be positioned in the center of the pouches 34, 36, 38 below the inlets 92, 96, 104 allowing the perfusion solution to pass between the diversion region 110 and the sides 90. While the second and third diversion regions 112, 114 may be positioned laterally in the pouches and touching the sides 90 of the pouches 34, 36, 38 near the outlets 94, 100, 106 allowing the perfusion solution to be diverted to the center of the pouches 34, 36, 38.

In the preferred embodiment the oxygenator subsystem 30 is situated in the perfusion solution flow path 10 between a venous reservoir 40 and an arterial reservoir 42. A controlled gassing subsystem 28 is connected to the oxygenator subsystem 30 to provide the necessary gases to oxygenate the perfusion solution. The controlled gassing subsystem 28 includes a pH sensor 44, a pH meter 54, an in-line controller 52, a solenoid 48, a valve interface 56, CO₂ 46, and O₂ 50. The pH sensor 44 may be inserted in the flow path 10 after the venous reservoir 40 and just prior to the entry of the venous effluent or perfusate solution into the oxygenator subsystem 30. As the pH electrode 44 is situated in the venous effluent of the circulating perfusate it continuously monitors the pH, an in-line controller 52 receives input from the pH sensor 44 via a pH meter 54 connected to the controller 52. The controller 52 operates a valve interface 56 by way of solenoid 48 to intermittently release CO₂ 46 to the perfusate as it flows through the oxygenating pouches 34, 36, 38. The intermittent release of CO₂ 46 controls the pH at a constant value rather than a range. Similarly, this configuration of oxygenating pouches 34, 36, 38, allows for each of the pouches 34, 36, 38 to have its own flow of oxygen 50 and carbon dioxide 46. Individual oxygen 50 and carbon dioxide 46 flow in conjunction with continuous pH measurement and control minimizes the need for CO₂ 46. The overall result is that the configuration of the pH sensing and control subsystem of the gassing subsystem 28, placed in tandem with the oxygenator subsystem 30 provides tight control of oxygen levels in the circulating perfusate solution and superior control over maintaining the stable pH, as described in greater detail below. Alternatively, the oxygenating pouches 34, 36, 38 may share a flow of oxygen 50 and carbon dioxide 46 that enters into the container 58 where the pouches 34, 36, 38 of the oxygenator subsystem 30 are located.

The gases may be introduced from the gassing subsystem 28 to the oxygenator subsystem 30 through multiple gassing ports which allow for a higher level of sensitive control of the partial pressures of both oxygen 50 and carbon dioxide 46. The net result is rather than having control within a range of pH, the combination of multiple inline oxygenating pouches 34, 36, 38 in constant communication with the gassing subsystem 28 results in a stable pH tightly controlled at a single set point. The ability to maintain pH at a predetermined set-point eliminates the pH fluctuations which occur within a range. The ability to control the respiratory gases at a set point of pH results in optimized oxygen consumption by a kidney allograft (greater than 0.12 cc/minute/gram).

When perfusing the human organ 20, at near-normothermic temperatures, the levels of oxygen in the circulating perfusate can be affected by a number of factors including the weight of the organ, extent of ischemic damage which has occurred, vascular flow rate, organ's ability to extract molecular oxygen associated with the resuscitation of oxidative metabolism, and the desired level of oxygenation to support the organ 20 without the toxic effects of over oxygenation. The combination of the oxygenating membranes 34, 36, 38 in communication with the gassing subsystem 28 allows for tight control of the oxygen levels within the non-toxic range of 100 to 350 mmHg. The sensor 44 monitoring pH provides real-time sensing capabilities of the perfusate pH and in tandem with the oxygenator subsystem 30 maintains tight control of the pH around the set point by the intermittent gassing of carbon dioxide 46 with continuous oxygen 50 gassing. The set point may be a single set point or may have divergent set points wherein the system has a first set point for activation and a second set point for deactivation of the valve interface or second controller 56.

The perfusion solution is continuously oxygenated and re-circulated via a closed system by introducing 100% oxygen 50 through the three sequential oxygenating pouches 34, 36, 38 to maintain the predetermined partial pressure of oxygen. For example the desired PaO₂ of 250 mmHg or alternatively a PaO₂ of 150 mHg can be selected. The system of the present invention includes a mechanism for maintaining a perfusate pH at a selected value. Regulation of pH and CO₂ levels of the perfusate is achieved by the controlled intermittent gassing of the perfusion solution with CO₂ 46. The gassing subsystem 28 continuously monitors the pH, for example, by the pH electrode or sensor 44 in the venous effluent in the perfusion path 10 just prior to contact with the oxygenating pouches 34, 36, 38. The pH sensor 44 is operatively connected to a controller 52 and solenoid 48 for regulation of the CO₂ gassing required to maintain pH at a pre-determined set point.

When the pH rises above the pre-determined set point, a small burst of CO₂ 46 is released to keep the pH at the appropriate value. For example, if the desired pH of 7.40 is pre-determined then when the pH rises to 7.405 a burst of CO₂ 46 for approximately 3-5 seconds will restore the pH to 7.40. Rather than achieving a range as described in U.S. Pat. No. 6,582,953 of 7.32 to 7.38, the present invention eliminates pH fluctuations. The three oxygenating pouches 34, 36, 38 in tandem in conjunction with the gassing subsystem 28 that maintains PaO₂, PaCO₂ and pH at stable and constant pre-determined values is especially effective in mimicking the tight physiologic control of blood pH and the respiratory gasses by the respiratory system in vivo.

The organ chamber may additionally include a conduit, of the type described in U.S. Pat. No. 6,582,953, for receiving venous outflow of perfusion solution and preventing its contact with the outer surfaces of the organ 20. The conduit may be located within the organ chamber 32 and may deliver the venous outflow of perfusate from the organ 20 directly to the venous reservoir 40 to minimize the risk of contamination by avoiding contact of the perfusate solution with the external surfaces of the organ 20 and the internal surfaces of the organ chamber 32. The conduit may be disposed beneath the vein to provide support to the vein allowing for the ligated end of the vein to be connected with a conduit, such as, a length of tubing which may be slipped over the end of the vein without the need for cannulation. Alternatively the ligated end of the vein may be placed in the conduit and the perfusate from the organ 20 allowed to drain down the conduit without contacting the organ 20.

The organ chamber system may also include a monitoring subsystem in which the monitoring of various parameters of the perfusion solution is microprocessor controlled. Such a system may include a microprocessor and sensors disposed in the perfusate flow path, and coupled to the microprocessor for sensing at least one of the temperature, pH, pressure, flow rate, PaO₂, PaCO₂, NO flux, and products of synthesis of the perfusion solution and providing the sensed information to the microprocessor. In addition, to assist in the repairing of damage to an organ 20 due to warm ischemia, stem cells may be used by injecting the stem cells into the perfusate solution just prior to the solution entering the organ 20 for regenerative processes. The organ chamber system may also include a means for exchanging perfusate which is connected to the reservoir 42 and allows for removal of a portion of the depleted perfusate from the reservoir 42 and replacing it with fresh perfusate.

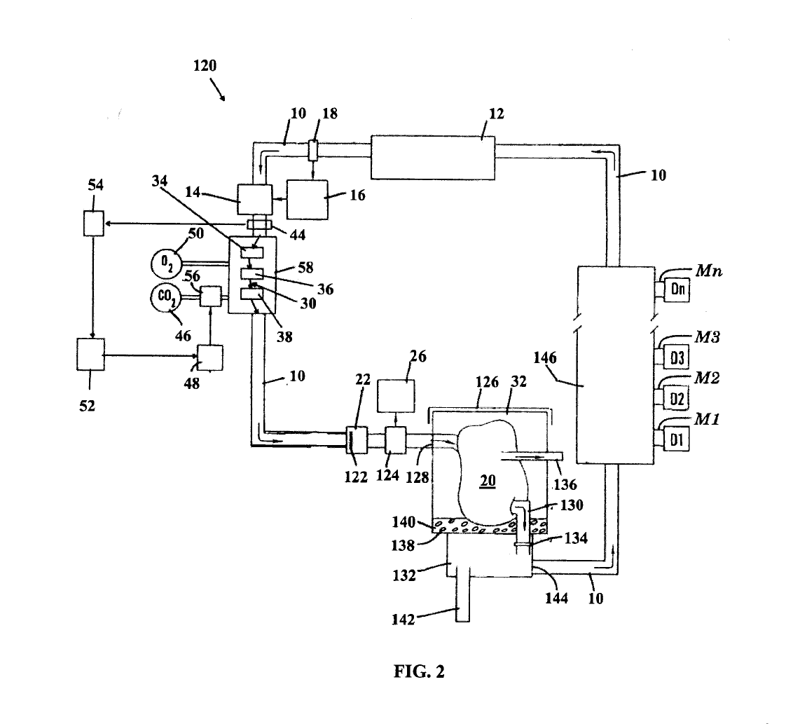

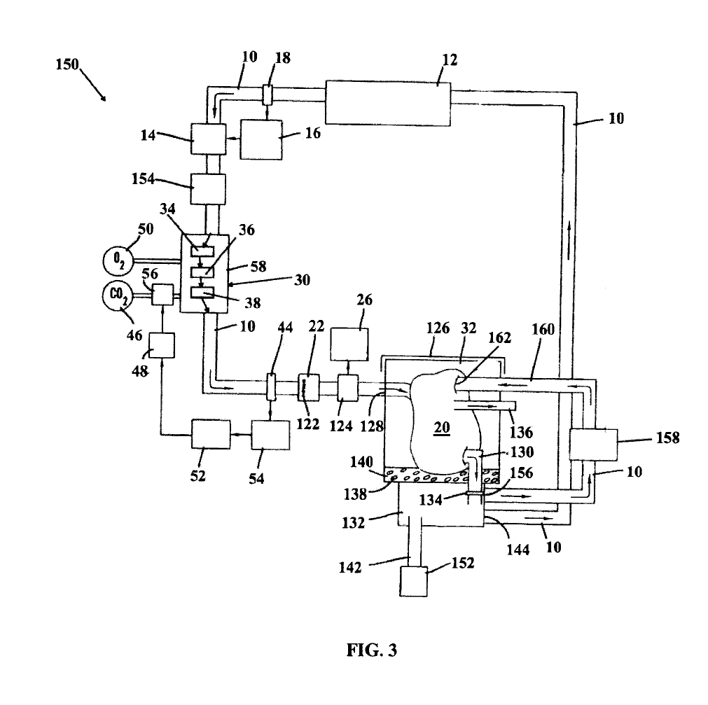

Referring now to FIG. 2, there is a diagram of another embodiment of the organ perfusion circulation path of the present invention. In most instances, only one perfusion path is necessary. However, when the organ to be metabolically maintained is a liver, two perfusion circuits are required. A two perfusion circuit path is illustrated in FIG. 3 and described in greater detail below. As seen in FIG. 2, the organ perfusion circulation path is shown in an exsanguinous metabolic support system 120 which includes an organ chamber 32 for ex vivo warm perfusion to maintain an isolated organ or tissue 20 at a near normal metabolic rate. All perfusate available for circulation through the system 60 is propelled through the circulation path 10 by a pump 12. Before the perfusate enters the organ 20, it passes through a heat exchanger 14 which is controlled by a temperature controller 16 that receives input from a temperature sensor 18 situated in the perfusate path 10 as described above with reference to FIG. 1.

The perfusate solution then passes through the oxygenator system 30 with three oxygenating pouches 34, 36, 38 as described above with reference to FIGS. 4-8. The pH sensor 44 may be inserted in the flow path 10 before the oxygenator system 30. The pH sensor 44 is situated in the circulation path 10 and continuously monitors the pH. An in-line controller 52 receives input from the pH sensor 44 through a pH meter 54. The controller 52 operates a valve interface 56 by way of a solenoid 48 to release the CO₂ 46 into the perfusate as it flows through the oxygenating pouches 34, 36, 38. The perfusate may then pass through a bubble trap 22 to debubble the perfusate just prior to entering the organ chamber 32. The bubble trap 22 may include one or more manometers 122 as described in U.S. Pat. No. 6,582,953. A flow meter 26 may also be incorporated into the warm perfusion system in the perfusate path 10 prior to the organ 20 to measure the flow rate of the perfusate solution. The flow meter 26 may also include a sensor 124 to monitor the flow rate of the perfusate.

The organ chamber 32 includes an organ 20 with a top or lid 126 and one or more perfusate inlets 128. The perfusate enters the organ chamber 32 from the one or more inlets 128 which mate with the organ 20. The organ chamber 32 also includes a conduit 130 for delivering the venous outflow of perfusate from the organ 20 directly to a reservoir 132 to minimize the risk of contamination by avoiding contact of the perfusate with the external surfaces of the organ 20 and the internal surfaces of the organ chamber 32. The perfusate may be filtered through a filter 134. The conduit 130 may also include a vein support which supports the vein at a position proximal the intersection of the vein with the exterior wall of the organ 20 and is capable of holding the open end of the vein securely against a piece of tubing which conducts the perfusate away from the organ 20 and into the reservoir 132. The perfusate may flow into the reservoir 132 through openings 138 in the support means 140. The support means 140 is positionable within the organ chamber 32 for supporting the organ 20. A means 142 for exchanging perfusate is connected to the reservoir 132 and allows for removal of a portion of the depleted perfusate from the reservoir 132 and replacing it with fresh perfusate. The perfusate outlet 144 allows the perfusate to exit the reservoir 132 and pass to the effluent reservoir 146. The effluent reservoir 146 is in fluid communication with the fluid pathway 10 and one or more nutrient reservoirs D1, D2, D3, Dn. Nutrient reservoirs D1, D2, D3, Dn are in communication with the reservoir 146 via semi-permeable membranes M1, M2, M3, Mn. The nutrient reservoirs D1, D2, D3, Dn and semi-permeable membranes are of the type described in U.S. Pat. No. 6,582,953. The organ chamber 32 may further comprise a means 136 for collecting organ product from the organ 20.

Referring now to FIG. 3, an organ perfusion circulation path is shown in an EMS system 150 which includes an organ chamber 32 for ex vivo warm perfusion to maintain an isolated organ or tissue 20 at a near normal metabolic rate. The EMS system 150 includes two perfusion circuit paths, a first perfusion path 10 and a second perfusion path 160. The system 150 is of the type described above with reference to FIG. 2 and further including two volume-regulatable pumps 152 and 154. The pumps 152 and 154 exchange the perfusate in the system 150, the pump 152 is connected to means 142 in the reservoir 132 to extract depleted perfusate and the pump 154 is situated in the perfusate path 10 just prior to the oxygenator subsystem 30. As depleted perfusate solution is removed by pump 152 an equal volume of fresh perfusate is immediately introduced into the system 150 by pump 154. The system 150 may also include a second effluent outlet 156 which allows the perfusate to be drawn by means of a pump 158 into a second perfusion path 160 carrying perfusate to the portal vein 162 of the liver.

The effectiveness of the invention in supporting the organ culture of various organs and tissues was evaluated. The invention was used to establish efficacy with paired human kidneys and porcine kidneys.

### Example 1

Paired human kidneys were used to compare pH control and oxygen consumption using a commercially available disposable organ chamber and the organ chamber system described above with reference to FIGS. 1-3 of the present invention. The paired kidneys were flushed with approximately 200 cc of the same exsanguinous metabolic support solution that was warmed to 32° C. After flushing, the kidneys were weighed. One kidney was then placed in a commercially available organ chamber and near-normothermic perfusion was initiated. The paired kidney was instead placed in the organ chamber of the present invention and similarly warm perfused. The perfusions were conducted for time periods of 12 to 24 hours. A set point for pH of 7.35 for each perfusion was targeted. During the period of ex vivo perfusion, the kidneys were continually monitored at periodic intervals. The monitoring entailed determining the pH of the circulating perfusate. In addition, samples of the circulating perfusate in the arterial line and one from the venous effluent were collected to determine the PaO₂ in each sample using a Radiometer blood gas machine to calculate the oxygen consumption rates. The oxygen consumption was calculated as follows:

$$Oxygen consumption = \frac{\{ ( {PaO}_{2} artery - {PaO}_{2} vein ) \times Flow Rate ( \frac{c c}{minute} ) \}}{Weight ( gram )}$$

An oxygen consumption rate of greater than 0.12 cc/minute/gram is considered normal.

The test kidneys warm perfused with the organ chamber of the present invention had stable perfusion pressures and constant vascular flow rates throughout the testing period. Following the period of warm perfusion, the kidneys were again weighed. In these kidneys the weight gain resulting from the ex vivo warm perfusion was less than 10%. The test kidneys displayed constant pH with essentially no fluctuations, ranging from 7.34 to 7.35. These kidneys also exhibited significantly higher rates of oxygen consumption compared to the control kidneys. The results are listed in Table 1.

In contrast, in the paired control kidneys that were instead perfused using the commercially available organ chamber, the perfusion pressures rose following several hours and the vascular flow rates diminished over time. When these kidneys were again weighed there was an average weight gain of 35%+/−9. The control kidneys displayed fluctuations in the targeted pH ranging from 7.31 to 7.48. In addition declining rates of oxygen consumption were observed over time. The results are listed in Table 1.

TABLE 1

| | Commercial Organ | Organ Chamber of the | |
|---|---|---|---|
| | Chamber (n = 5) | Invention (n = 5) | |
| pH* | 7.37 (+/−0.05) | 7.35 (+/−0.01) | |
| Oxygen | 0.067 (+/−0.3) | 0.162 (+/−0.01) | P < 0.001 |
| consumption* | | | |

*Data represented as the mean of the hourly time intervals with calculated standard deviations

### Example 2

Porcine kidneys were recovered, the renal artery was cannulated and the vasculature was flushed of blood using approximately 120 cc of perfusate warmed to 32° C. Some kidneys were then placed in the commercially available organ chamber and others in the organ chamber of the present invention and all kidneys were then warm perfused for eighteen hours. During the period of warm perfusion the kidneys were monitored for perfusion pressures, vascular flow rates, and oxygen consumption.

Following the warm perfusion period the kidneys were reimplanted with contralateral nephrectomy. The kidneys were reimplanted with comparable reanastomosis times ranging from 19 to 30 minutes. During the posttransplant period the serum creatinine values were determined daily to assess the posttransplant function. A serum creatinine value of less than 2.0 mg/dL was considered as normal.

Similar to the results of Example 1, the organ chamber of the present invention supported higher oxygen consumption rates than the control kidneys that were instead perfused using the commercially available organ chamber. The PaO₂ was kept constant at approximately 300 mmHg in the organ chamber of the present invention that was in contrast to the control organ chamber that had a fluctuating and considerably lower PaO₂ of less than 150 mmHg (+/−4.2). The higher rates of oxygen consumption using the organ chamber of the present invention were observed at all testing points during the eighteen hours of perfusion in comparison to the control organ chamber.

Most importantly, the higher oxygen consumption rates correlated with lower posttransplant serum creatinine values indicative of better renal function. This difference was particularly apparent in the early posttransplant period. In the test kidneys perfused using the organ chamber of the present invention, the mean 24-hour posttransplant serum creatinine value was less than 2.5 mg/dL. In contrast, the 24-hour posttransplant serum creatinine was higher in the kidneys perfused using the commercially available organ chamber. The results are listed in Table 2.

TABLE 2

| | Oxygen | 24-H Posttransplant |
|---|---|---|
| | Consumption* | sCr+ |
| Commercial Organ | 0.059 cc/min/g +/− | 3.3 mg/dL |
| Chamber | 0.04 | |
| Present Invention | 0.159 cc/min/g +/− | 2.1 mg/dL |
| | 0.01 | |
| | P < 0.001 | P < 0.05 |

*Mean of hourly oxygen consumption rates calculated as described in Example 1

These results demonstrate that the optimized support of oxygen consumption during a period of ex vivo near-normothermic perfusion that is provided by the organ chamber of the present invention represents improved renal preservation. Similarly, the poorer oxygen consumption observed in the control kidneys that were instead preserved using a commercially available organ chamber correlated with insufficient preservation that leads to renal damage that can be seen at 24 hours posttransplant.

Although the example embodiments have been depicted and described in detail herein, it will be apparent to those skilled in the relevant art that various modifications, additions, and substitutions can be made without departing from its essence and therefore these are to be considered to be within the scope of the following claims.

1. An organ chamber, the chamber comprising:
an oxygenator comprising:
at least one gaseous exchange pouch;
an inlet at a superior end of the at least one gaseous exchange pouch; and
an outlet at an inferior end of the at least one gaseous exchange pouch.

2. The organ chamber of claim 1, further comprising:
a controlled gassing subsystem for regulation of respiratory gases, maintenance and control of the pH of a perfusion solution comprising:
a first controller for continuously introducing oxygen at a constant concentration into the perfusion solution; and
a second controller for intermittently introducing carbon dioxide into the perfusion solution wherein the second controller has at least one set point for activation and deactivation of the second controller.

3. The organ chamber of claim 2, further comprising:
a perfusion subsystem including one or more perfusion fluid paths for circulating the perfusion solution.

4. The organ chamber of claim 3, further comprising:
a container for holding an organ, the container being situated in the perfusion fluid path and having one or more perfusion solution inlets and one or more perfusion solution outlets.

5. The organ chamber of claim 4, further comprising:
a temperature controller for controlling temperature of the perfusion solution.

6. The organ chamber of claim 5, further comprising:
an venous reservoir in the container for receiving venous outflow and wherein the venous reservoir is disposed within the fluid paths.

7. The organ chamber of claim 6, further comprising:
a fluid passageway connecting the venous reservoir to the inlet of the oxygenator.

8. The organ chamber of claim 7, further comprising:
at least one sensor disposed within the fluid passageway for monitoring at least one parameter of the perfusion solution.

9. The organ chamber of claim 8, wherein the parameter is selected from flow rate, pH, PaO₂, PaCO₂, temperature, vascular pressure, NO flux and a metabolic indicator.

10. The organ chamber of claim 9, wherein the metabolic indicator is selected from oxygen consumption, glucose consumption, consumption of at least one citric acid cycle component, CO₂ production, and a product of new synthesis.

11. The organ chamber of claim 8, further comprising:
a second sensor disposed within the fluid passageway prior to a cannulated artery wherein measurements taken from the at least one sensor and the second sensor are used to measure metabolism across the organ.

12. The organ chamber of claim 2, wherein the controlled gassing subsystem comprises at least one gassing port.

13. The organ chamber of claim 2, wherein the controlled gassing subsystem includes two ports.

14. The organ chamber of claim 5, further comprising:
at least one of an arterial reservoir, a heat exchanger, an oxygenator, and a single direction flow pulsatile pump head disposed within the container, the perfusion subsystem, or the controlled gassing subsystem.

15. The organ chamber of claim 5, further comprising:
an arterial reservoir connected to the outlet of the oxygenator for receiving preservation solution that has circulated through the organ and the oxygenator.

16. The organ chamber of claim 5, further comprising:
a perfusion conduit for delivering perfusion solution to the organ.

17. The organ chamber of claim 5, further comprising:
means positionable within the container for supporting the organ within the container and for inhibiting lateral and rotational movement of the organ within the container.

18. The organ chamber of claim 5, wherein the first controller modifies the constant O₂-tension to a targeted value simultaneously with continuously introducing oxygen.

19. The organ chamber of claim 5, wherein the at least one set point of the second controller is a single value.

20. The organ chamber of claim 5, wherein the at least one set point of the second controller includes a first set point for activation and a second set point for deactivation.

21. The organ chamber of claim 5, further comprising:
a venous support member positionable within the container for supporting a vein of the organ and holding the vein adjacent to a perfusate outlet of the container thereby maintaining the vein in fluid communication with the perfusate outlet without cannulation of the vein.

22. The organ chamber of claim 21, wherein the perfusate outlet is a conduit disposed within the container wherein the conduit is connectable to the organ for receiving venous outflow of a perfusion solution from the organ and preventing the outflow from contacting the outer surface of the organ.

23. The organ chamber of claim 22, further comprising:
a venous reservoir disposed within the container for receiving venous outflow from the conduit and wherein the venous reservoir is disposed within the perfusion fluid paths.

24. The organ chamber of claim 23, further comprising:
at least one sensor disposed within the conduit for monitoring at least one parameter of the perfusion solution.

25. The organ chamber of claim 23, further comprising:
a fluid passageway connecting the venous reservoir and the oxygenator within the perfusion fluid paths.

26. The organ chamber of claim 25, further comprising:
at least one sensor disposed within the fluid passageway for monitoring at least one parameter of the perfusion solution.

27. An oxygenator for an organ chamber, comprising:
at least one gaseous exchange pouch;
an inlet at a superior end of the at least one gaseous exchange pouch; and
an outlet at an inferior end of the at least one gaseous exchange pouch.

28. The oxygenator of claim 27, wherein the at least one gaseous exchange pouch includes three gaseous exchange pouches.

29. The oxygenator of claim 27, wherein the at least one gaseous exchange pouch comprises:
a first sheet opposing a second sheet with a liquid impermeable perimeter seal, wherein the liquid impermeable perimeter seal has a first end, a second end, and two sides, and wherein the first sheet and second sheet are permeable to gases;
an inlet at the first end, wherein a perfusion solution enters the at least one gaseous exchange pouch; and
an outlet at the second end, wherein the perfusion solution exits the at least one gaseous exchange pouch.

30. The at least one gaseous exchange pouch of claim 29, further comprising:
at least one diversion region for redirecting the perfusion solution as it travels from the inlet to the outlet.

31. The oxygenator of claim 27, wherein the inlet is coupled to a reservoir of venous effluent and the outlet enables a re-oxygenated venous effluent to be recirculated to an organ.
